(19) United States
(12) Patent Application Publication
(10) Pub. No.: US 2021/0370768 A1
(43) Pub. Date: Dec. 2, 2021

(54) ACCELERATOR DEVICE

(71) Applicant: DENSO CORPORATION, Kariya-city (JP)

(72) Inventors: Takuto KITA, Kariya-city (JP); Yasuhiro OTAKA, Obu-city (JP)

(21) Appl. No.: 17/399,678

(22) Filed: Aug. 11, 2021

Related U.S. Application Data
(63) Continuation of application No. PCT/JP2020/019758, filed on May 19, 2020.

(30) Foreign Application Priority Data
May 21, 2019 (JP) 2019-094976

(51) Int. Cl. B60K 26/02; B29C 45/14

(52) U.S. Cl. CPC B60K 26/02; B29K 2101/12; B29C 45/14

(57) ABSTRACT

An accelerator device includes a stepping member that receives a stepping by a driver, a case attachable to a vehicle body, an internal movable mechanism housed in the case, and a rotation angle detector. The internal movable mechanism includes a shaft that rotates in respond to a stepping to the stepping member, and the rotation angle detector outputs a signal corresponding to a rotation angle of the shaft via a plurality of terminals. Output ends of the plurality of terminals are arranged in an arrangement different from a line arrangement when being viewed from an output side of the plurality of terminals.

### CROSS REFERENCE TO RELATED APPLICATION

The present application is a continuation application of International Patent Application No. PCT/JP2020/019758 filed on May 19, 2020, which designated the U.S. and claims the benefit of priority from Japanese Patent Application No. 2019-094976 filed on May 21, 2019. The entire disclosures of all of the above applications are incorporated herein by reference.

### TECHNICAL FIELD

The present disclosure relates to an accelerator device.

### BACKGROUND

An accelerator device includes a stepping member which receives a stepping from a driver, a shaft that rotates according to the stepping applied to the stepping member, and a rotation angle detector that outputs a signal according to the rotation angle of the shaft. The rotation angle detector outputs a signal to an external device via a plurality of terminals.

### SUMMARY

The present disclosure provides an accelerator device in which output ends of a plurality of terminals are arranged in an arrangement different from a line arrangement when being viewed from an output side of the plurality of terminals. The plurality of terminals may be formed into an integrated terminal unit using a resin, and then assembled to other parts.

### BRIEF DESCRIPTION OF DRAWINGS

The above and other objects, features and advantages of the present disclosure will become more apparent from the following detailed description made with reference to the accompanying drawings. In the drawings:

FIG. 1 is a diagram for explaining a configuration of an accelerator device;

FIG. 2 is a diagram showing an accelerator device in a fully closed state of an accelerator;

FIG. 3 is a diagram showing an accelerator device in a fully open state of the accelerator;

FIG. 4 is an enlarged view of a rotation angle detector;

FIG. 5 is a diagram showing an IC mounting unit and a plurality of terminals;

FIG. 6 is a diagram showing arrangement positions of the IC mounting unit and the plurality of terminals;

FIG. 7 is a diagram showing a plurality of terminals before a resin mold is formed;

FIG. 8 is a diagram showing a configuration of a rotation angle detector;

FIG. 9 is a diagram showing a terminal unit and a mold before an injection molding;

FIG. 10 is a diagram showing a configuration of a rotation angle detector; and

FIG. 11 is a diagram showing a configuration of a rotation angle detector.

### DESCRIPTION OF EMBODIMENTS

In an accelerator device, if output ends of a plurality of terminals are arranged in a line when being viewed from an output side of the plurality of terminals, the outer shape of the rotation angle detector becomes larger in an arrangement direction in which the respective output ends of the plurality of the terminals are arranged. Because the position of a vehicle body to which the accelerator device is assembled is at the foot area of a driver's seat and tends to be subject to spatial restrictions, there is a need for miniaturization in each part of the accelerator device. Therefore, there is a demand for a technique capable of miniaturizing the outer shape of the rotation angle detector, at the position where the output ends of the plurality of terminals are arranged.

According to an embodiment of the present disclosure, an accelerator device is provided. The accelerator device includes a stepping member that receives a stepping by a driver, a case attachable to a vehicle body, an internal movable mechanism housed in the case, and a rotation angle detector. The internal movable mechanism includes a shaft that rotates in respond to the stepping to the stepping member, and the rotation angle detector outputs a signal corresponding to a rotation angle of the shaft via a plurality of terminals. Output ends of the plurality of terminals are arranged in an arrangement different from a line arrangement when being viewed from an output side of the plurality of terminals. Accordingly, the outer shape of the accelerator device at the position where the output ends of the plurality of terminals are arranged can be effectively reduced as compared with a case in which the output ends of the plurality of terminals are arranged in a single line. Therefore, it becomes easy to cope with spatial restrictions that occur when the accelerator device is assembled to the vehicle body.

The plurality of terminals may be formed into an integrated terminal unit using a resin, and then assembled to other parts.

For example, the terminal unit includes a contact portion for defining an outer shape of the rotation angle detector, and the contact portion of the terminal unit is brought into contact with a mold die in a resin injection direction when a resin mold, in which the terminal unit is included, is injection-molded using the mold die. In this case, a resin used for molding the terminal unit and a resin used for molding the resin mold may be the same thermoplastic resin, or a resin used for molding the terminal unit may have a melting point equal to or lower than a melting point of a resin used for molding the resin mold.

### A. First Embodiment

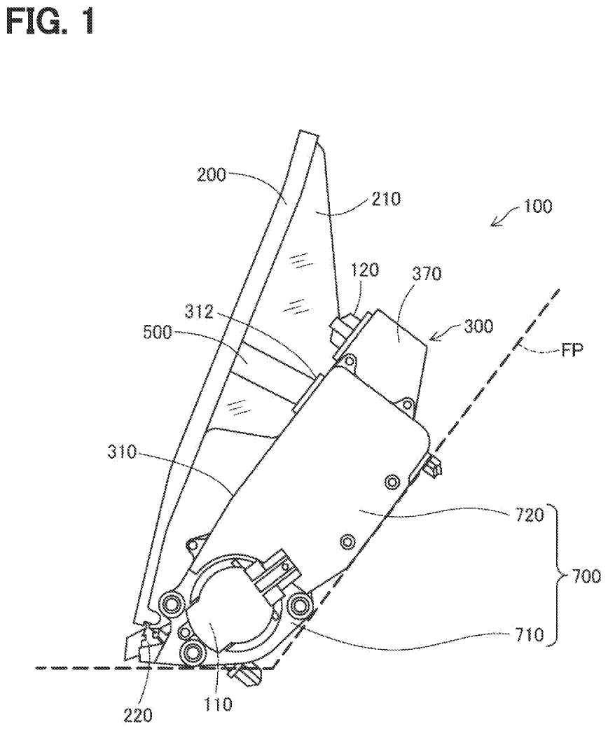

As shown in FIG. 1, an accelerator device 100 is configured to be attachable to a floor panel FP that constitutes a part of a vehicle body in a vehicle. Unless otherwise specified, the description of the structure and arrangement of the accelerator device 100 described below means the structure and arrangement in an installed state in which the accelerator device 100 is attached to the vehicle body. For example, the terms “upward” and “upper side” mean upward and upper side in the installed state in which the accelerator device 100 is installed on the vehicle body. The same applies to other terms and explanations.

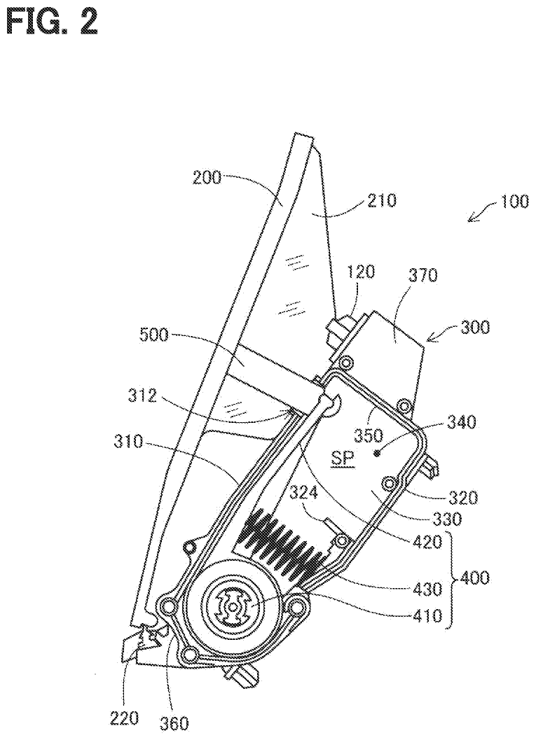

The accelerator device 100 includes a pad 200 configured to receive a stepping by a driver, a case 300 attachable to a vehicle body, an internal movable mechanism 400 housed in the case 300 as shown in FIG. 2, and an arm 500 configured to connect the pad 200 and the internal movable mechanism 400 while penetrating through an opening 312 provided in an outer wall surface of the case 300. The opening 312 can also be referred to as a “through hole 312”. As described above, the accelerator device 100 having a structure in which the pad 200 provided on the driver side of the case 300 and the internal movable mechanism 400 housed in the case 300 are connected by the arm 500 is called an “organ structure type” accelerator device.

The pad 200 is configured to be stepped on by the driver. The speed of the vehicle is adjusted according to a stepping degree of the driver with respect to the pad 200. In other words, the stepping degree is a ratio (%) of an operation range to the total movable range of the pad 200, and can be called as an accelerator opening. A plate-shaped side guard portion 210 is provided on the side surface of the pad 200. A lower end of the pad 200 is supported by a fulcrum member 220 provided at a lower end of the case 300, and the pad 200 is rotatable about a contact point with the fulcrum member 220. The side guard portion 210 is a member that guards a gap between the pad 200 and the case 300 so that the driver's foot is not pressed between the pad 200 and the case 300.

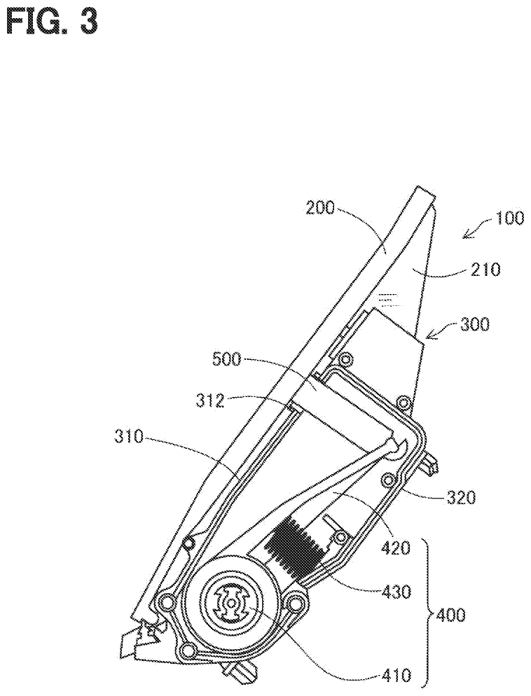

FIGS. 2 and 3 show the accelerator device 100 in a state where a rotation angle detector 110 and a cover 700 are removed. As shown in FIG. 2, the case 300 is an accommodation wall surrounding an internal accommodation space SP, and includes a front wall 310 facing the pad 200, a back wall 320 facing the front wall 310, an open side surface 330 forming one side surface between the front wall 310 and the back wall 320, a side wall 340 facing the open side surface 330, an upper surface wall 350 defining an upper end of the internal accommodation space SP, and a lower surface wall 360 facing the upper surface wall 350. Strictly speaking, since the open side surface 330 is not a wall surface, the walls 310, 320, 340 to 360 other than the open side surface 330 function as accommodation walls surrounding the internal accommodation space SP. As shown in FIG. 1, the open side surface 330 is covered and closed by a cover 700 made of a first cover portion 710 and a second cover portion 720. In the present embodiment, the first cover portion 710 and the second cover portion 720 are configured as separate bodies, but they may be configured as a single member.

The front wall 310 is provided with an opening 312 through which the arm 500 passes. A kickdown switch 120 is installed on the outer wall surface of the case 300 above the opening 312. The kickdown switch 120 is a switch for detecting “kickdown”, which is an operation in which the driver shifts down the gear at once by strongly depressing the pad 200. A storage chamber 370 for accommodating the kickdown switch 120 is formed at an uppermost portion of the case 300.

As shown in FIG. 2, a plate-shaped wall portion 324 extending diagonally upward from the back wall 320 toward the front wall 310 is provided on an inner surface of the back wall 320 of the case 300. The wall portion 324 guides water to a path avoiding an installation position of an urging member 430 so that the water entering from the opening 312 of the case 300 does not directly reach the urging member 430 when it falls in the vertical direction.

As shown in FIG. 2, the internal movable mechanism 400 includes a shaft 410 rotatably supported by the case 300, a pedal 420 extending diagonally upward from the outer peripheral portion of the shaft 410, and the urging member 430 that is housed below the pedal 420 and applies force to the pedal in the direction in which the accelerator is in a fully closed state. The fully closed state of the accelerator will be described later. As shown in FIG. 1, the first cover portion 710 covers a lower portion of the open side surface 330 of the case 300, which corresponds to the side surface portion of the shaft 410. The second cover portion 720 covers an upper portion of the open side surface 330 above the first cover portion 710.

As shown in FIG. 1, a rotation angle detector 110 that generates an accelerator opening signal according to a rotation angle of the shaft 410 is provided at the outside of the shaft 410. In the present embodiment, the rotation angle detector 110 includes a detection circuit including a Hall element that detects an orientation of a permanent magnet (not shown) embedded in the shaft 410. However, it is also possible to use various types of accelerator opening sensors instead of the rotation angle detector 110.

The pedal 420 of the internal movable mechanism 400 is connected to the pad 200 via the arm 500. The force input from the driver and received by the pad 200 is transmitted to the pad 200 via the arm 500. In accordance with the force degree transmitted, the pedal 420 moves toward the back wall 320 while rotating the shaft 410.

As shown in FIGS. 2 and 3, the urging member 430 is disposed below the pedal 420. In the present embodiment, the urging member 430 is a string-wound spring, but an urging member having another configuration can also be used.

In the constituent elements of the accelerator device 100, the elements other than the shaft 410 and the urging member 430 can be formed of resin. The overall configuration of the accelerator device 100 described above is an example, and a part thereof can be arbitrarily omitted or modified. For example, the side guard portion 210 and the wall portion 324 may be omitted.

Hear, the fully closed state of the accelerator is a state in which the stepping amount of the driver with respect to the pad 200 is zero. On the other hand, the fully open state of the accelerator is a state in which the stepping amount of the driver with respect to the pad 200 is the limit within the movable range of the pad 200. In other words, the fully closed state of the accelerator is a state in which the accelerator opening degree is 0%, and the fully open state of the accelerator is a state in which the accelerator opening degree is 100%.

FIG. 2 shows the accelerator device 100 in the fully closed state of the accelerator. FIG. 3 shows the accelerator device 100 in the fully open state of the accelerator. In the fully closed state of the accelerator, when the pad 200 receives an input force from the driver, the accelerator device 100 shifts from the state shown in FIG. 2 toward the state shown in FIG. 3

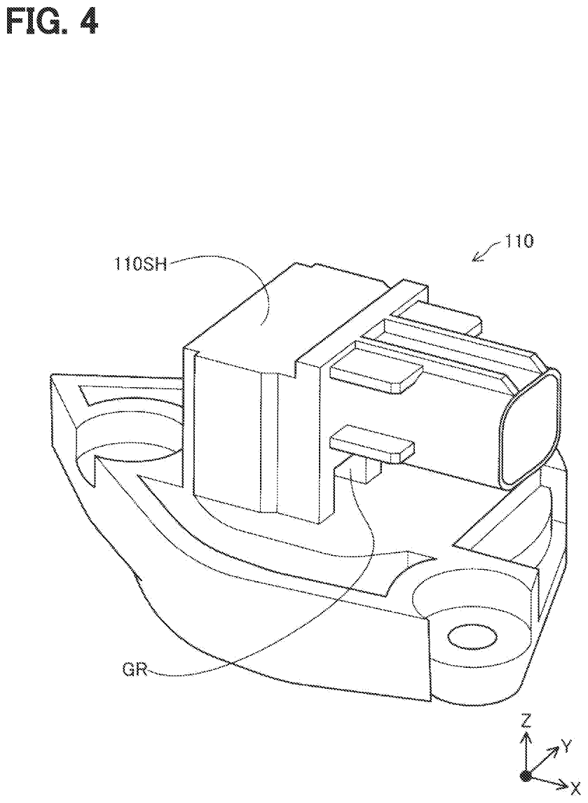

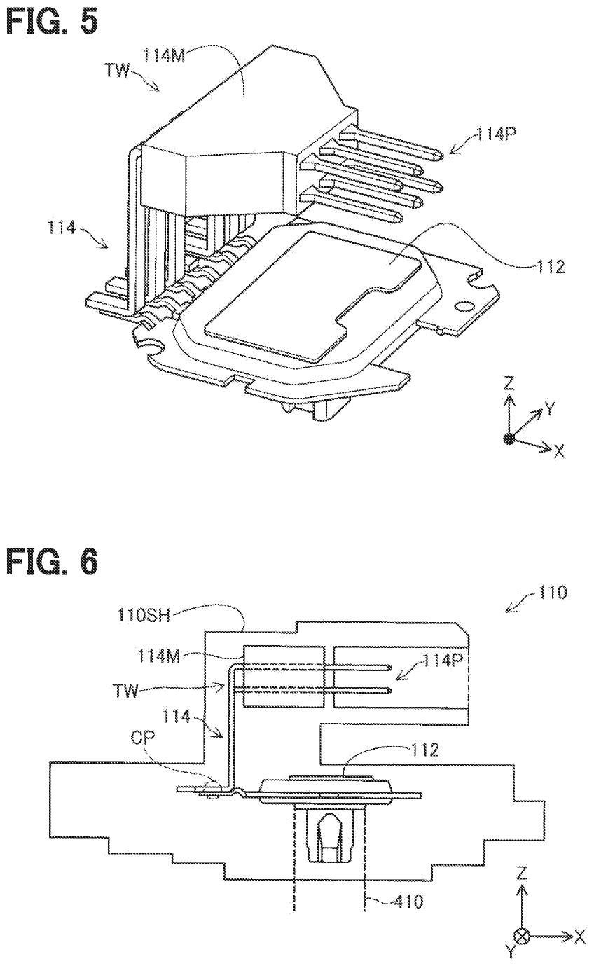

FIG. 4 is an enlarged view showing the rotation angle detector 110. FIG. 4 shows a resin mold 110SH that defines the outer shape of the rotation angle detector 110. FIG. 5 shows an IC mounting unit 112 and a plurality of terminals 114 included in the resin mold 110SH. FIG. 6 shows the positions of the IC mounting unit 112 and the plurality of terminals 114 arranged in the resin mold 110SH. The XYZ axes of FIG. 4 are an X-axis, a Y-axis, and a Z-axis as three spatial axes orthogonal to each other. The XYZ axes in FIG. 4 correspond to the XYZ axes in FIGS. 5 and 6.

The IC mounting unit 112 includes a detection circuit including a Hall element. The shaft 410 fits into an axial portion of the IC mounting unit 112 extending in the −Z axis direction, as shown in FIG. 6. In FIG. 6, the shaft 410 is shown by a broken line. In the state where the shaft 410 is fitted in the IC mounting unit 112, the Hall element included in the IC mounting unit 112 is arranged in the magnetic field formed by the permanent magnet embedded in the shaft 410. When the shaft 410 rotates, the IC mounting unit 112 outputs a signal corresponding to the rotation angle of the shaft 410 detected by the Hall element via the plurality of terminals 114.

The plurality of terminals 114 are metal members. Each of the plurality of terminals 114 is in contact with the IC mounting portion 112 at a contact portion CP, as shown in FIG. 6. The plurality of terminals 114 are configured to output signals input from the IC mounting unit 112 toward their respective output ends 114P via the contact portion CP. In this embodiment, the plurality of terminals 114 are six terminals, as an example. Each output end 114P extends toward the +X axis direction. The output ends 114P of the plurality of terminals 114 are arranged in an arrangement different from one linear arrangement when being viewed from a side of the +X axis, which is the output side of the plurality of terminals 114. The linear arrangement referred to here is an arrangement composed of 1 row and n columns, or m rows and 1 column (n and m are arbitrary integers). In this embodiment, the respective output ends 114P of the plurality of terminals are arranged in an array composed of two rows and three columns.

The plurality of terminals 114 are formed into an integrated terminal unit TW using resin. The term “terminal unit TW” as used herein refers to a plurality of terminals 114 bundled and integrated by a resin mold 114M. When the rotation angle detector 110 is manufactured, the plurality of terminals 114 are processed into the terminal unit TW and then assembled to the IC mounting unit 112 which is another component. More specifically, the plurality of terminals 114 are welded to the IC mounting portion 112 via the contact portion CP in a state of being processed into the terminal unit TW. Since the plurality of terminals 114 are integrated and then assembled to the IC mounting portion 112, it is possible to prevent the positional relationship between the output ends 114P from shifting before and after assembly with other parts. Further, when the resin mold 110SH including the terminal unit TW is molded by injection molding using a mold die, it is possible to prevent each of the plurality of terminals 114 from being deformed by the resin flowing into the mold die.

The resin used for forming the resin mold 114M and the resin used for forming the resin mold 110SH are the same thermoplastic resin. Therefore, when the resin mold 110SH is molded by injection molding using a mold die, the surface of the resin mold 114M of the terminal unit TW is melted by the resin flowing into the mold die, and the inflowing resin and the surface of the resin mold 114M are welded together. Therefore, it is difficult for a gap to be generated at the interface between the resin mold 110SH and the resin mold 114M.

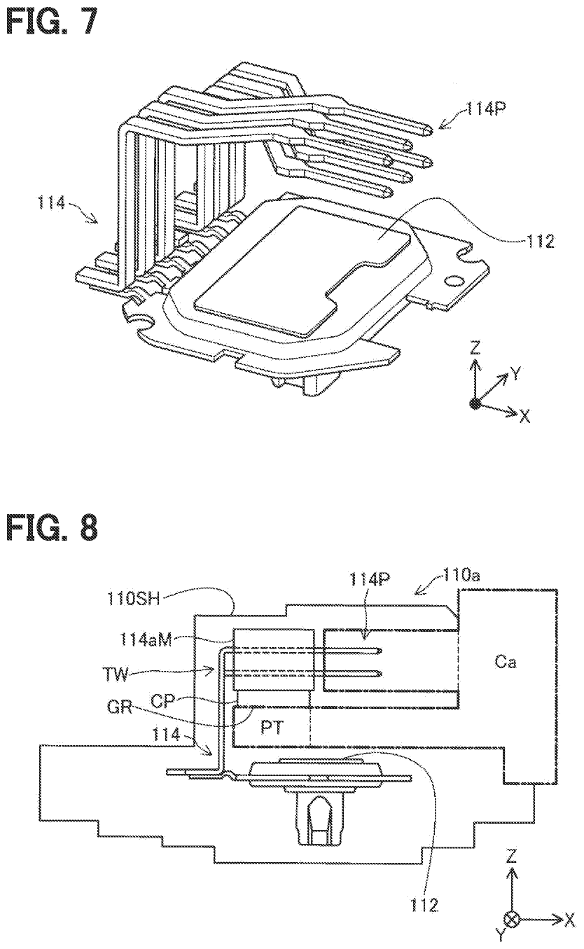

FIG. 7 shows a plurality of terminals 114 before the resin mold 114M is formed. As shown in FIG. 7, the plurality of terminals 114 cross over at a position on the side in the −X axis from the output end 114P thereof. By changing the grade separation between the plurality of terminals 114, it is possible to easily respond to a design change of a connector that fits with the output ends 114P. Further, by reducing the distance between the output ends 114P of the plurality terminals 114, it is possible to reduce the outer shape of the rotation angle detector 110 at the arrangement position where the output ends 114P of the plurality of the terminals 114 are arranged.

According to the embodiment described above, the outer shape of the output ends 114P lined up at the arrangement position can be miniaturized, as compared with an arrangement in which the output ends of the plurality of terminals are arranged side by side in one line (e.g., an array composed of 1 row and n columns, or m rows and 1 column). Therefore, it becomes easy to cope with the spatial restrictions that occur when the accelerator device 100 is assembled to the vehicle body.

In the embodiment described above, the plurality of terminals 114 are integrated as the integrated terminal unit TW using a resin at a position other than the output ends 114P, and the output ends 114P of the plurality of terminals 114 are positioned on the same surface (e.g., Z-Y surface in FIG. 5) in an array composed of 2 rows or more and 2 columns or more. Thus, the outer shape and size of the rotation angle detector 110 can be effectively changed at the arrangement position where the output ends 114P of the plurality of the terminals 114 are arranged. Furthermore, the terminal unit can be easily connected to the rotation angle detector 110 by a resin mold.

### B. Second Embodiment

An accelerator device 100 of the second embodiment is provided with a rotation angle detector 110a that is different from the rotation angle detector 110, but the other parts of the accelerator device 100 of the second embodiment are similar to those of the accelerator device 100 of the first embodiment. The same reference signs as in the first embodiment denote the same or substantially equal structural components, and the description of the first embodiment regarding the same reference signs are incorporated by reference.

FIG. 8 shows the rotation angle detector 110a and a mold die Ca. Similar to the first embodiment, a plurality of terminals 114 of the rotation angle detector 110a are formed into an integrated terminal unit TW using a resin. A resin mold 114aM used for integration of the plurality of terminals 114 has a contact portion CP, unlike the resin mold 114M in the rotation angle detector 110 of the above first embodiment shown in FIG. 6.

The contact portion CP of the resin mold 114aM contacts a protruding portion PT of the mold die Ca. The mold die Ca is a part of the mold die that is used when the resin mold 110SH is molded by injection molding. The protruding portion PT of the mold die Ca is a portion for forming the groove GR shown in FIG. 4.

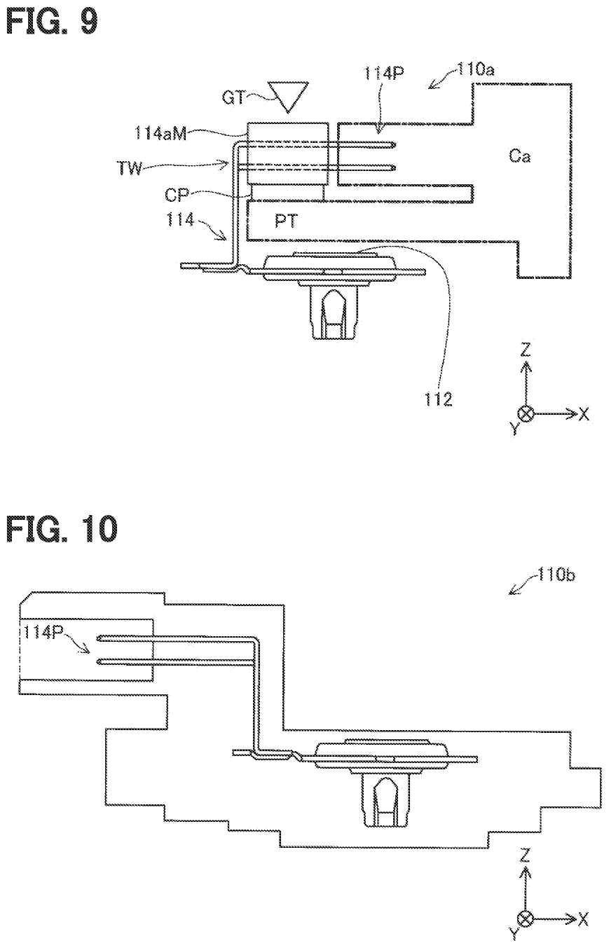

FIG. 9 shows the terminal unit TW and the mold die Ca before the resin mold 110SH is molded by the injection molding. The resin used for molding the resin mold 110SH is injected from the gate GT to the −Z axis direction. The contact portion CP is brought into contact with the protruding portion PT of the mold die Ca by the resin injection in the −Z axis direction. As described above, since the terminal unit TW is in contact with the mold die Ca via the contact portion CP, it is possible to prevent each of the plurality of terminals 114 from being deformed by the resin flowing into the mold die.

### C. Other embodiments

In the above-described embodiment, the respective output ends 114P of the plurality of terminals 114 are arranged in an array composed of two rows and three columns when being viewed from a side of the +X axis, corresponding the output side of the plurality of terminals 114; however, the disclosure is not limited to this. For example, the output ends 114P of the plurality of terminals 114 may be arranged in an array composed of 3 rows and 2 columns or an array composed of 4 rows and 2 column, when being viewed from the side of the +X axis, which corresponds to the output side of the plurality of terminals 114. The respective output ends 114P may be arranged in an array composed of rows and columns of arbitrary integers as long as they are arranged in an arrangement different from the one linear arrangement.

In the above-described embodiment, the resin used for molding the resin mold 114M and the resin used for molding the resin mold 110SH are the same thermoplastic resin, but the present disclosure is not limited to this. For example, the resin used for molding the resin mold 114M is a thermoplastic resin different from the thermoplastic resin used for molding the resin mold 110SH, and is a thermoplastic resin having a melting point or less of the thermoplastic resin used for the resin mold 110SH. Even in this case, when the resin mold 110SH is molded by injection molding using a mold die, the surface of the resin mold 114M of the terminal unit TW is melted by the resin flowing into the mold die, and the inflowing resin for the resin mold 110SH and the surface of the resin mold 114M are welded together. Therefore, it is difficult for a gap to be generated at the interface between the resin mold 110SH and the resin mold 114M.

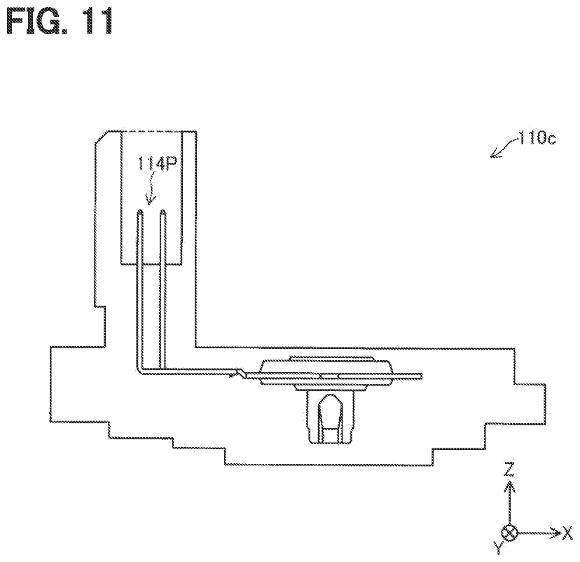

In the above-described embodiment, the output ends 114P of the plurality of terminals 114 extend in the +X axis direction, but the present disclosure is not limited to this. For example, the output ends 114P of the plurality of terminals 114 included in a rotation angle detector 110b shown in FIG. 10 may extend in the −X axis direction, or the output ends 114P of the plurality of terminals 114 included in a rotation angle detector 110c shown in FIG. 11 may extend in the +Z axis direction. The output ends 114P of the plurality of terminals 114 may extend in any direction depending on the spatial design of the foot area of the driver's seat.

In the above-described embodiment, the plurality of terminals 114 are grade-separated, but the present disclosure is not limited to this. For example, the plurality of terminals 114 may extend without crossing overpasses.

The present disclosure should not be limited to the embodiments or modifications described above, and various other embodiments may be implemented without departing from the scope of the present disclosure. For example, the technical features in each embodiment corresponding to the technical features in the form described in the summary may be used to solve some or all of the above-described problems, or to provide one of the above-described effects. In order to achieve a part or all, replacement or combination can be appropriately performed. Also, if the technical features are not described as essential in the present specification, they can be deleted as appropriate.

What is claimed is:

1. An accelerator device comprising:
a stepping member configured to receive a stepping by a driver;
a case configured to be attachable to a vehicle body;
an internal movable mechanism housed in the case and including a shaft that is rotatable in response to the stepping onto the stepping member; and
a rotation angle detector configured to output a signal corresponding to a rotation angle of the shaft via a plurality of terminals, wherein
output ends of the plurality of terminals are arranged in an arrangement different from a linear arrangement when being viewed from an output side of the plurality of terminals.

2. The accelerator device according to claim 1, wherein
the plurality of terminals are integrated as an integrated terminal unit using a resin at a position other than the output ends, and
the output ends of the plurality of terminals are positioned on a surface in an array composed of 2 rows or more and 2 columns or more.

3. The accelerator device according to claim 2, wherein
the terminal unit is connected to the rotation angle detector by a resin mold.

4. The accelerator device according to claim 3, wherein
the resin used for the terminal unit and a resin used for the resin mold are the same thermoplastic resin.

5. The accelerator device according to claim 3, wherein
the resin used for the terminal unit has a melting point equal to or lower than a melting point of a resin used for the resin mold.

6. A method for manufacturing an accelerator device including an internal movable mechanism having a shaft that is rotatable in response to a stepping onto a stepping member, and a rotation angle detector configured to output a signal corresponding to a rotation angle of the shaft via a plurality of terminals, the method comprising:
integrally molding the plurality of terminals to an integrated terminal unit using a resin to have output ends arranged in an arrangement different from a linear arrangement when being viewed from an output side of the plurality of terminals; and
assembling the integrated terminal unit to the internal movable mechanism and rotation angle detector.

7. The manufacturing method according to claim 6, wherein
the terminal unit includes a contact portion for defining an outer shape of the rotation angle detector, and the contact portion of the terminal unit is brought into contact with a mold die in a resin injection direction when a resin mold, in which the terminal unit is included, is injection-molded using the mold die.

8. The manufacturing method according to claim 7, wherein
a resin used for molding the terminal unit and a resin used for molding the resin mold are the same thermoplastic resin.

9. The manufacturing method according to claim 7, wherein
a resin used for molding the terminal unit has a melting point equal to or lower than a melting point of a resin used for molding the resin mold.

10. The manufacturing method according to claim 6, wherein
the output ends of the plurality of terminals are positioned on a surface in an array composed of 2 rows or more and 2 columns or more.
